(19) United States
(12) Patent Application Publication
(10) Pub. No.: US 2009/0254713 A1
(43) Pub. Date: Oct. 8, 2009

(54) ACCESS CONTROL TO PARTITIONED BLOCKS IN SHARED MEMORY

(75) Inventor: Jong-Sik Jeong, Seoul (KR)

Correspondence Address: BIRCH STEWART KOLASCH & BIRCH, PO BOX 747, FALLS CHURCH, VA, 22040-0747, US

(73) Assignee: MTEKVISION CO., LTD., Seoul (KR)

(21) Appl. No.: 11/909,121

(22) PCT Filed: Sep. 22, 2005
(86) PCT No.: PCT/KR05/03144

§ 371 Date: Sep. 19, 2007

(30) Foreign Application Priority Data
Mar. 25, 2005 (KR) 10-2005-0024926

(51) Int. Cl. G06F 12/00

(52) U.S. Cl. 711/151; 711/E12.001

(57) ABSTRACT

A method for controlling multiple access to partitioned areas of a shared memory and a portable terminal having the shared memory are disclosed. According to an embodiment of the present invention, the storage area of a shared memory is partitioned to a plurality of storage areas, and each control unit accesses a storage area through each access port to store data and transfers an authority to access the pertinent storage area to the other control unit, thereby allowing access by the other control unit. With the present invention, the data communication time between the plurality of control units can be minimized, and the process efficiency of each control unit can be optimized.

### TECHNICAL FIELD

The present invention is directed to a portable terminal, particularly to a portable terminal having a plurality of processors.

### BACKGROUND ART

A portable terminal refers to a compact electronic device that is designed to be easily carried by a user in order to perform functions such as game or mobile communication. A portable terminal can be a mobile communication terminal, a personal digital assistant (PDA), or a portable multimedia player (PMP).

A mobile communication terminal generally refers to a device designed to allow a mobile user to telecommunicate with a remotely-located receiver. Through technological developments, however, the latest mobile communication terminals are equipped with extra features, such as camera and multimedia data playback, to the essential functions of mobile communication, short message communication, and address book.

FIG. 1 shows a block diagram of a conventional mobile communication terminal having a camera function.

Referring to FIG. 1, the mobile communication terminal 100 having a camera function comprises a high frequency processing unit 110, an A/D conversion unit 115, a D/A conversion unit 120, a control unit 125, a power supply 130, a key input 135, a main memory 140, a display 145, a camera 150, an image processing unit 155, and a support memory 160.

The high frequency processing unit 110 processes a high frequency signal, which is transmitted or received through an antenna.

The A/D conversion unit 115 converts an analog signal, outputted from the high frequency processing unit 110, to a digital signal and sends to the control unit 125.

The D/A conversion unit 120 converts a digital signal, outputted from the control unit 125, to an analog signal and sends to the high frequency processing unit 110.

The control unit 125 controls the general operation of the mobile communication terminal 100. The control unit 125 can comprise a central processing unit (CPU) or a micro-controller.

The power supply 130 supplies electric power required for operating the mobile communication terminal 100. The power supply 130 can be coupled to, for example, an external power source or a battery.

The key input 135 generates key data for, for example, setting various functions or dialing of the mobile communication terminal 100 and sends to the control unit 125.

The main memory 140 stores an operating system and a variety of data of the mobile communication terminal 100. The main memory 140 can be, for example, a flash memory or an EEPROM (Electrically Erasable Programmable Read Only Memory).

The display 145 displays the operation status of the mobile communication terminal 100 and an external image photographed by the camera 150.

The camera 150 photographs an external image (a photographic subject), and the image processing unit 155 processes the external image photographed by the camera 150. The image processing unit 155 can perform functions such as color interpolation, gamma correction, image quality correction, and JPEG encoding. The support memory 160 stores the external image processed by the image processing unit 155.

As described above, the mobile communication terminal 100 having a camera function is equipped with a plurality of processors (that is, a main control unit and one or more supplementary control unit for performing additional functions). In other words, as shown in FIG. 1, the control unit 125 for controlling general functions of the mobile communication terminal 100 and the image processing unit 155 for controlling the camera function are included. Moreover, each processor is structured to be coupled with an independent memory.

The supplementary control unit can take different forms depending on the kinds of additional functions, with which the portable terminal is equipped. For example, the supplementary control unit for controlling the camera function can process functions such as JPEG encoding and JPEG decoding; the supplementary control unit for controlling the movie file playback function can process functions such as video file (e.g., MPEG4, DIVX, H.264) encoding and decoding; and the supplementary control unit for controlling the music file playback function can process functions such as audio file encoding and decoding. Of course, there can be a supplementary control unit that can process various aforementioned functions altogether. Each of these control units has an individual memory for storing the data processed by the control unit. Therefore, according to the prior art, it is necessary to increase the number of control units and memories as portable terminals become increasingly multifunctional.

FIG. 2 illustrates an example of a coupling structure among a main control unit, a supplementary control unit, and their corresponding memories in accordance with the conventional art.

Referring to FIG. 2, the main control unit 210 and the supplementary control unit 220 communicate information through bus #1; the main control unit 210 is coupled with the main memory 230 through bus #2; and the supplementary control unit 220 is coupled to the supplementary memory 240 through bus #3. A bus refers to a common-purpose electric pathway that is used to transmit information between the control unit, the main memory, and the input/output in a device such as a computer. A bus comprises a line for data, designating the address of each device or the location of the memory, and a line for distinguishing a variety of data transmission operation to be processed.

As illustrated in FIG. 2, each control unit 210, 220 is independently coupled with each memory 230, 240. Therefore, the main control unit 210 reads the data stored in the main memory 230 and transmits the data to the supplementary control unit 220 through a host interface or requests the supplementary control unit 220 to read the data stored in the supplementary memory 240. In other words, in case certain data is processed in the main control unit 210 and the supplementary control unit 221, respectively, the main control unit 210 accesses the main memory 230 to perform a necessary process and then transmits the processed data to the supplementary control unit 220, and the supplementary control unit 220 re-processes the received data and stores in the supplementary memory 240. Then, the supplementary control unit 220 transmits the data stored in the supplementary memory 240 back to the main control unit 210 to have it stored in the main memory 230.

In this case, the larger the amount of data, communicated between the main control unit 210 and the supplementary control unit 220, is, the more time each control unit 210, 220 spends on the operation (i.e. memory access, host interface operation) requested by the other control unit rather than the operation requested by its own processor.

This problem causes a bottleneck problem in data communication between the main control unit 210 and the supplementary control unit 220 as the amount of data to be processed and the functions performed by a portable terminal increase.

As a result, the problems described above weaken the overall performance of a multi-function portable terminal.

### DISCLOSURE

### Technical Problem

Therefore, in order to solve the problems described above, it is an object of the present invention to provide a portable terminal having a shared memory and a method for controlling multiple access to partitioned blocks of the shared memory that can minimize the data transmission time between control units, by partitioning the storage area of the shared memory into a plurality of partitioned blocks and allowing a plurality of control units to access each partitioned block.

It is another object of the present invention to provide a portable terminal having a shared memory and a method for controlling multiple access to partitioned blocks of the shared memory that can optimize the operation speed and efficiency of each control unit, by allowing the storage area of the shared memory, partitioned into a plurality of blocks, to be accessed by a plurality of control units such that each control unit can handle its own process only.

It is yet another object of the present invention to provide a portable terminal having a shared memory and a method for controlling multiple access to partitioned blocks of the shared memory that can easily control the shared memory in software, by using partitioned blocks of the shared memory.

It is still another object of the present invention to provide a portable terminal having a shared memory and a method for controlling multiple access to partitioned blocks of the shared memory that can process data highly efficiently by eliminating the loss of time needed to communicate the data, stored in a specific memory, between control units.

### Technical Solution

In order to achieve the above objects, an aspect of the present invention features a portable terminal having a shared memory with partitioned blocks that are accessible by a plurality of control units.

According to a preferred embodiment of the present invention, the portable terminal comprises a memory unit; a supplementary control unit coupled to the memory unit through an AP (additional processor)-ME (Memory) bus, the supplementary control unit processing and storing raw data in accordance with a process order, the raw data being stored in the memory unit, the memory unit being accessed through the AP-ME bus; and a main control unit coupled to the memory unit through an MP (main processor)-ME bus and coupled to the supplementary control unit through an MP-AP bus, the main control unit transmitting the process order to the supplementary control unit through the MP-AP bus. A storage area of the memory unit is accessible by the supplementary control unit through the AP-ME bus and by the main control unit through the MP-ME bus, and the memory unit comprises a first port, for transmitting and receiving data to and from the supplementary control unit through the AP-ME bus, and a second port, for transmitting and receiving data to and from the main control unit through the MP-ME bus.

In case a first control unit (either the main control unit or the supplementary control unit) accesses any one of the partitioned storage areas, the first control unit can transmit access status information to a second control unit (the other of either the main control unit or the supplementary control unit) through the MP-AP bus.

Or, in case the second control unit attempts to access a partitioned storage area to write data while the first control unit is accessed to the same partitioned storage area and is writing data, the memory unit can transmit an inaccessible message to the second control unit.

Area partition information corresponding to the size of the partitioned storage areas can be set by the first control unit, which is either the main control unit or the supplementary control unit, and can be transmitted to the second control unit, which is the other of either the main control unit or the supplementary control unit, through the MP-AP bus.

The process order can comprise instruction information on the process type of the raw data and a storage location of the raw data. Moreover, the process order can further comprise location information for storing raw data processed to correspond to the instruction information.

The plurality of partitioned storage areas can comprise a data delivery area for delivering data between the supplementary control unit and the main control unit.

In order to achieve the above objects, an aspect of the present invention features a method for controlling access by a plurality of control units to partitioned areas of a shared memory and/or a recorded medium recording the method thereof.

According to a preferred embodiment of the present invention, the recorded medium tangibly embodies a program of instructions executable by a portable terminal to execute a method for controlling multiple access to partitioned blocks of a shared memory. The program is readable by the portable terminal, and the portable terminal comprises a main control unit and a supplementary control unit. The main control unit is coupled with the memory unit through an MP-ME bus. The supplementary control unit is coupled with the memory unit through an AP-ME bus. The main control unit and the supplementary control unit are coupled with each other through an MP-AP bus. The storage area of the memory unit is partitioned to a plurality of partitioned storage areas. The recorded medium executes the acts of a first control unit determining, in order to access any one of the partitioned storage areas, whether a second control unit is already accessed to the partitioned storage area, wherein the first control unit is either the main control unit or the supplementary control unit, and the second control unit is the other of either the main control unit or the supplementary control unit; the first control unit accessing the partitioned storage area if the second control unit is not accessed to the partitioned storage area; the first control unit writing data in the accessed partitioned storage area; and the first control unit terminating the access to the partitioned storage area.

In case the first control unit accesses any one of the partitioned storage areas, the first control unit can transmit access status information to the second control unit through the MP-AP bus.

In case the second control unit attempts to access a partitioned storage area to write data while the first control unit is accessed to the same partitioned storage area and is writing data, the memory unit can transmit an inaccessible message.

Area partition information corresponding to the size of the partitioned storage areas can be set by the first control unit and transmitted to the second control unit through the MP-AP bus.

### DESCRIPTION OF DRAWINGS

FIG. 1 shows a block diagram of a conventional mobile communication terminal having a camera function;

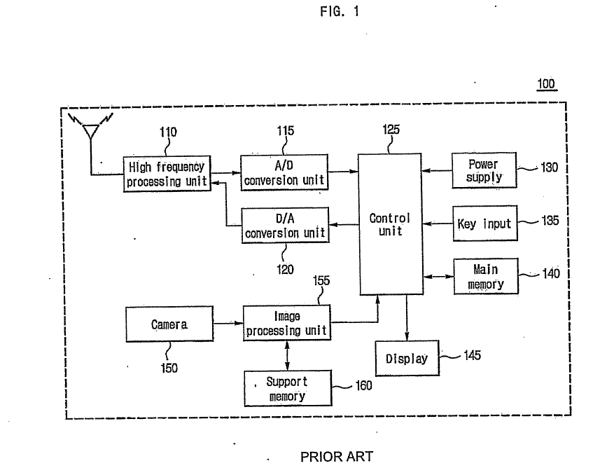

FIG. 2 shows a block diagram of an example of a conventional coupling structure between a main control unit, a supplementary control unit, and each memory;

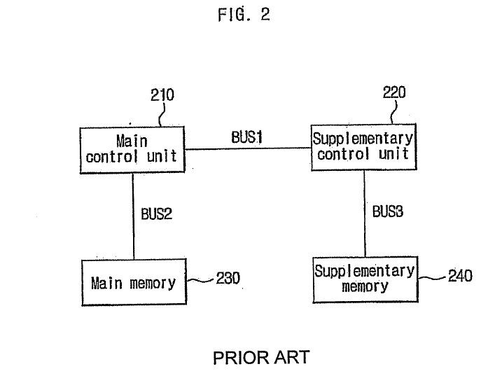

FIG. 3 shows a block diagram of a coupling structure between a main control unit, a supplementary control unit, and a memory unit, in accordance with a preferred embodiment of the present invention;

FIG. 4 shows a partition of the storage area of the memory unit in accordance with a preferred embodiment of the present invention;

FIG. 5 shows a flow chart of a control unit accessing a partitioned storage area in accordance with a preferred embodiment of the present invention; and

FIG. 6 shows a partition of the storage area of the memory unit in accordance with another preferred embodiment of the present invention.

### DESCRIPTION OF KEY ELEMENTS

210: Main control unit
220: Supplementary control unit
310: Memory unit

### MODE FOR INVENTION

The present invention, operative advantages of the present invention, and objects achieved by embodying the present invention shall be apparent with reference to the accompanying drawings and the description therein.

Hereinafter, preferred embodiments of the present invention shall be described in detail with reference to the accompanying drawings. To aid overall understanding of the present invention, the same reference numbers shall be assigned to the same means, regardless of the figure number. Moreover, the numbers (e.g., bus #1, bus #2, first, second, etc.) are only used in the description to identify identical or similar elements.

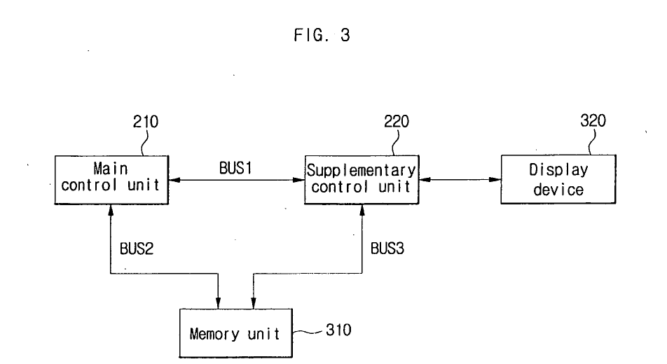

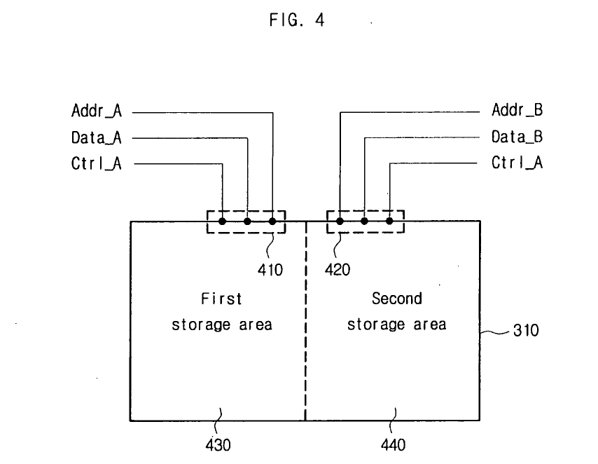

FIG. 3 is a block diagram showing a coupling structure between the main control unit, the supplementary control unit, and the memory unit, in accordance with a preferred embodiment of the present invention, and FIG. 4 shows a partition of the storage area of the memory unit in accordance with a preferred embodiment of the present invention;

Referring to FIG. 3, the main control unit 210 and the supplementary control unit 220 are coupled to transmit and receive data (e.g. process order, status information) to and from each other through bus #1 (i.e. an MP-AP (main processor-application processor) bus connecting the main control unit 210 and the supplementary control unit 220); the main control unit 210 and the memory unit 310 are coupled to transmit and receive data to and from each other through bus #2 (i.e. an MP-ME (memory) bus connecting the main control unit 210 and the memory 310); and the supplementary control unit 220 and the memory unit 310 are coupled to transmit and receive data to and from each other through bus #3 (i.e. an AP-ME bus connecting the supplementary control unit 220 and the memory unit 310). A bus refers to a common-purpose electric pathway that is used to transmit and receive information between the control unit, the main memory, and the input/output in a device such as a computer. Here, the main control unit 210 can be a processor that controls the general operation of a portable terminal. Also, the supplementary control unit 220 can be a dedicated processor for processing the MPEG4, 3-D graphic, and camera functions. A peripheral device such as a display device 320 can be coupled to the back of the supplementary unit 220. The kind of data to be outputted through the display device 320 can be controlled by the main control unit 210 or the supplementary control unit 220.

The memory unit 310 is structured to be used by a control unit or a plurality of control units coupled to the memory unit 310, and must have the number of access ports corresponding to the number of control units equipped in the structure or sharing the memory unit 310.

For example, in a structure of the memory unit 310 coupled to both the main control unit 210 and the supplementary control unit 220, as shown in FIGS. 3 and 4, the two control units 210, 220 use one memory unit 310, thereby necessitating the memory unit 310 to have 2 access ports. In other words, the two access ports are configured to be identified as a first port 410 and a second port 420, having the first port and the second port connect to the main control unit 210 and the supplementary control unit 220, respectively. Each of the main control unit 210 and the supplementary control unit 220 can use an independent clock.

The storage area of the memory unit 310 can be partitioned to the number of partitions corresponding to the number of control units coupled to the memory unit 310. This is to allow each control unit to access each partition at the same time to write data. For example, in case 2 control units are connected to the memory unit 310, as shown in FIG. 4, the memory unit 310 can be partitioned to 2 blocks (i.e. first storage area 430, second storage area 440). Each partitioned block 430, 440 can be individually accessed as long as it is not partitioned to be a dedicated block for a specific control unit and it is not simultaneously accessed. This is to maintain the temporal consistency of the data consecutively by setting the process to complete one side before starting the next process. Of course, the memory unit 310 can be partitioned to more than 2 storage blocks even though only 2 control units are coupled to the memory unit 310.

The size of the partitioned block, that is, the first storage area 430 and the second storage area 440, of the memory unit 310 can be configured to be predetermined by default, partitioned to a certain size by the main control unit 210 and/or the supplementary control unit 220, or varied whenever necessary (for example, when the data to be written is bigger than the writable area) by the main control unit 210 and/or the supplementary control unit 220. In other words, the address information on the partitioned storage area of the memory unit 310 can be set and managed by the main control unit 210, the address information set by the main control unit 210 is provided to and shared by the supplementary control unit 220. Of course, the address information can also be set and managed by the supplementary control unit 220, and, as necessary, one of the control units can have an address setting authority to supply the set address information to the other control unit to have the address information shared. In this case, the information on the partitioned storage area of the memory unit 310 can be recognized by each control unit when the portable terminal is booted. The storage area can be partitioned in units of bank in case the memory is an SDRAM. An SDRAM usually comprises an RAS address, a CAS address, and a Bank address, and it is common that there are 4 banks. Here, the 4 banks can be grouped in two to have each group assigned as the first storage area 430 and the second storage area 440, respectively.

Although FIG. 4 shows the first port 410 on the first storage area 430 side and the second port 420 on the second storage area 440 side, this is only for the convenience of illustration and does not mean that only the storage area of one side are accessible by each port 410, 420. Therefore, it should be evident that any storage area 430, 440 can be accessed by each port 410, 420. However, as described earlier, if one of the control units is accessed to one of the storage areas in order to write data, the other control unit must be restricted from accessing the storage area. The plurality of control units 210, 220 can be restricted from simultaneously accessing the first storage area 430 or the second storage area 440 by having the first accessed control unit notify the other control unit of the access (e.g. accessed address information) or having the memory unit 310 notify, if one of the control units access the shared area, the other control unit of the access. In other words, it is possible for the main control unit 210 and the supplementary control unit 220 to process data by simultaneously accessing the memory unit 310 through independent routes, and in this case collision between the two control units can be prevented.

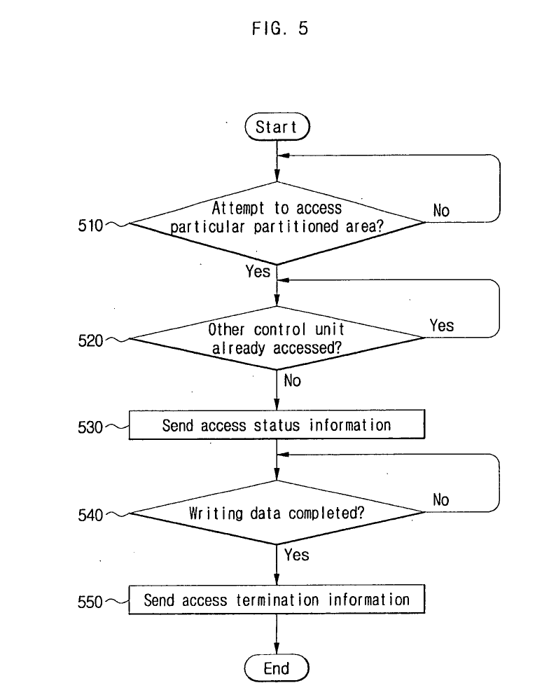

FIG. 5 is a flowchart of a control unit accessing a partitioned storage area in accordance with a preferred embodiment of the present invention.

The storage area of the memory unit 310 of the present invention can be partitioned to a plurality of storage areas 430, 440, and each control unit can write or read data by accessing one of the partitioned storage units through an access port. In other words, while the main control unit 210 is accessed to the first storage area 430, the supplementary control unit 220 can freely access the second storage area 440. Therefore, each control unit can simultaneously access each partitioned storage area of the memory unit 310 to perform the necessary data process. If a plurality of control units are accessed to one partitioned storage area simultaneously, however, the data consistency can be damaged, for which a preventive measure is required. Of course, it may be allowed to have one control unit write data while the other control unit read data although a plurality of control units are accessed to the same partitioned storage area at the same time. Below, a method for not allowing a plurality of control units to access the same partitioned storage area will be described with reference to FIG. 5.

Referring to FIG. 5, in step 510, it is determined whether a control unit (i.e. one of the main control unit 210 or the supplementary control unit 220, hereinafter referred to as “first control unit”) is to access a particular partitioned storage area (i.e. the first storage area 430 or the second storage area 440).

If there is no need to access the partitioned storage area, step 510 is repeated.

If the partitioned storage area needs to be accessed, however, the first control unit determines, in step 520, whether the other control unit (i.e. the other of either the main control unit 210 or the supplementary control unit 220, hereinafter referred to as “second control unit”) is already accessed to the partitioned storage area. The access by the second control unit to a partitioned storage area can be recognized through status information received from the pertinent control unit or the memory unit 310.

If the second control unit is accessed to the partitioned storage area, the process waits in step 520 until the second control unit terminates its access to the pertinent partitioned storage area.

If the partitioned storage area is accessible, however, the first control unit accesses the partitioned storage area, in step 530, and sends access status information, indicating the access by the first control unit to the partitioned storage area, to the second control unit. The access status information can be transmitted immediately before the access to the partitioned storage area, or can be transmitted to the second control unit by the memory unit 310 as described above.

In step 540, the first control unit determines whether the data to be written is completely stored in the accessed partitioned storage area. If the data to be written is not completely written, the pertinent data keeps being written, but if the data is completely written, the access to the pertinent partitioned storage area is terminated in step 550. Furthermore, the first control unit or the memory unit 310 sends access termination information of the partitioned storage area to the second control unit to enable the access by the second control unit.

As described above, the method for sharing the partitioned storage area in accordance with the present invention can allow the main control unit 210 and the supplementary control unit 220 to cross-access a plurality of partitioned storage areas, thereby making the real-time data delivery possible by writing the data to be delivered to the other control unit in a specific area of each partitioned storage area and providing the authority to access the pertinent partitioned storage area to the other control unit. Therefore, a prompt process becomes possible when the supplementary control unit 220 processes data in accordance with a process order by the main control unit 210. In this case, the storage address information of the data can be delivered to the other control unit, if necessary.

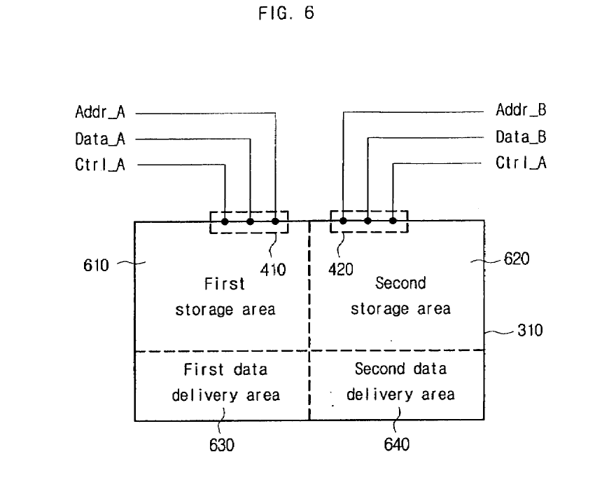

FIG. 6 shows a partition of the storage area of the memory unit in accordance with another preferred embodiment of the present invention.

As illustrated in FIG. 6, the storage area of the memory unit 310 can be partitioned to a plurality of storage areas (i.e. a first storage area 610, a second storage area 620, a first data delivery area 630, and a second data deliver area 640).

As illustrated in FIG. 4 earlier, in the method of partitioning the storage area of the memory unit 310 into a first storage area 410 and a second storage area 420 only, in order for the first control unit (i.e. either the main control unit 210 or the supplementary control unit 220) to allow the second control unit (i.e. the other of either the main control unit 210 or the supplementary control unit 220) to use the pertinent data when the first control unit has written the data in a partitioned storage area, the access to the pertinent partitioned storage area must be terminated.

If, as in FIG. 6, separate data delivery areas 630, 640 are equipped although a large amount of data is to be transferred between the main control unit 210 and the supplementary control unit 220, as in the case of a graphic process, the data to be delivered between each control unit can be transferred or copied to a data delivery area corresponding to each storage area, and then only the information needed for accessing the pertinent data delivery area can be delivered to the other control unit, thereby eliminating the need to surrender the authority to access the pertinent storage area 610, 620. After the data to be delivered to the other control unit is stored in a data delivery area, the pertinent control unit delivers the storage location information and a process order (e.g. instruction for process type of the pertinent data) of the pertinent data to the other control unit through a corresponding bus. Of course, the storage location information can be omitted if there is a default storage address in data delivery area. As such, by exchanging the authority to access the storage area, in which data is stored, between a plurality of control units, the data communication time for processing data can be saved.

Of course, in case a small amount of data is to be transmitted between a plurality of control units, the data can be communicated through a bus connected between each control unit although the access to the pertinent partitioned storage area is not terminated.

The drawings and detailed description are only an example of the present invention, serve only for describing the present invention, and by no means limit or restrict the spirit and scope of the present invention. Thus, any person of ordinary skill in the art shall understand that a large number of permutations and other equivalent embodiments are possible. The true scope of the present invention must be defined only by the spirit of the appended claims.

### INDUSTRIAL APPLICABILITY

As described above, a portable terminal having a shared memory and a method for controlling multiple access to partitioned blocks of the shared memory can minimize the data transmission time between control units by partitioning the storage area of the shared memory into a plurality of partitioned blocks and allowing a plurality of control units to access each partitioned block

Moreover, the present invention can optimize the operation speed and efficiency of each control unit by allowing the storage area of the shared memory, partitioned into a plurality of blocks, to be accessed by a plurality of control units such that each control unit can handle its own process only.

Furthermore, the present invention can easily control the shared memory in software by using partitioned blocks of the shared memory.

The present invention can also process data highly efficiently by eliminating the loss of time needed to communicate the data, stored in a specific memory, between control units.

What is claimed is:

1. A portable terminal comprising:
a memory unit;
a supplementary control unit coupled to said memory unit through a first bus, the supplementary control unit processing and storing raw data in accordance with a process order, the raw data being stored in said memory unit, the memory unit being accessed through said first bus; and
a main control unit coupled to said memory unit through a second bus and coupled to said supplementary control unit through a third bus, the main control unit transmitting said process order to said supplementary control unit through said third bus,
said memory unit comprises a first port and a second port, the first port transmitting and receiving data to and from said supplementary control unit through said first bus, said second port transmitting and receiving data to and from said main control unit through said second bus.

2. The portable terminal of claim 1, wherein, in case a first control unit accesses any one of the partitioned storage areas, the first control unit transmits access status information to a second control unit through said third bus, whereas said first control unit is either said main control unit or said supplementary control unit, and said second control unit is the other of either said main control unit or said supplementary control unit.

3. The portable terminal of claim 1, wherein, in case a second control unit attempts to access a partitioned storage area to write data while a first control unit is accessed to the same partitioned storage area and is writing data, said memory unit transmits an inaccessible message to said second control unit, whereas said first control unit is either said main control unit or said supplementary control unit, and said second control unit is the other of either said main control unit or said supplementary control unit.

4. The portable terminal of claim 1, wherein area partition information corresponding to the size of said partitioned storage areas is set by a first control unit, which is either said main control unit or said supplementary control unit, and is transmitted to a second control unit, which is the other of either said main control unit or said supplementary control unit, through said third bus.

5. The portable terminal of claim 1, wherein said process order comprises instruction information on the process type of said raw data and a storage location of said raw data.

6. The portable terminal of claim 5, wherein said process order further comprises location information for storing raw data processed to correspond to said instruction information.

7. The portable terminal of claim 1, wherein said plurality of partitioned storage areas comprise a data delivery area for delivering data between said supplementary control unit and said main control unit.

8. A recorded medium embodying a program of instructions executable by a portable terminal to execute a method for controlling multiple access to partitioned blocks of a shared memory, the program readable by said portable terminal, wherein said portable terminal comprises a main control unit and a supplementary control unit, said main control unit coupling with said memory unit through a second bus, said supplementary control unit coupling with said memory unit through a first bus, said main control unit and said supplementary control unit coupling with each other through a third bus, the storage area of said memory unit being partitioned to a plurality of partitioned storage areas, the recorded medium executing the acts of:
a first control unit determining, in order to access any one of the partitioned storage areas, whether a second control unit is already accessed to said partitioned storage area, wherein said first control unit is either said main control unit or said supplementary control unit, and said second control unit is the other of either said main control unit or said supplementary control unit;
said first control unit accessing said partitioned storage area if said second control unit is not accessed to said partitioned storage area;
said first control unit writing data in said accessed partitioned storage area; and
said first control unit terminating the access to said partitioned storage area.

9. The recorded medium of claim 8, wherein, in case said first control unit accesses any one of the partitioned storage areas, said first control unit transmits access status information to said second control unit through said third bus.

10. The recorded medium of claim 8, wherein in case said second control unit attempts to access a partitioned storage area to write data while said first control unit is accessed to the same partitioned storage area and is writing data, said memory unit transmits an inaccessible message.

11. The recorded medium of claim 8, wherein area partition information corresponding to the size of said partitioned storage areas is set by said first control unit and transmitted to said second control unit through said third bus.
